(19) United States
(12) Patent Application Publication
(10) Pub. No.: US 2018/0272459 A1
(43) Pub. Date: Sep. 27, 2018

(54) WELDER EXTENSION

(71) Applicant: Chris Elrod, MURIETTA, CA (US)

(72) Inventor: Chris Elrod, MURIETTA, CA (US)

(21) Appl. No.: 15/895,879

(22) Filed: Feb. 13, 2018

Related U.S. Application Data
(60) Provisional application No. 62/476,543, filed on Mar. 24, 2017.

(51) Int. Cl. B23K 11/31; B23K 9/173

(52) U.S. Cl. CPC B23K 11/318; B23K 9/325; B23K 9/173; B23K 11/314

(57) ABSTRACT

Methods and apparatuses for extending the range, reach, and/or length of a welding tool. A welding extension in accordance with an aspect of the present disclosure comprises an extension bar that couples between a welding tip and a welding head, such that material passes from the welding head to the welding tip through a bore in the extension bar.

### CROSS REFERENCE TO RELATED APPLICATIONS

The present application claims the benefit under 35 U.S.C. § 119(e) of U.S. Provisional Patent Application No. 62/476,543, filed Mar. 24, 2017 and entitled “WELDER EXTENSION,” which application is incorporated by reference herein in its entirety.

### BACKGROUND

### Field

Aspects of the present disclosure generally relate to welding and welding apparatuses. More specifically, the present disclosure relates to a welding extension arm.

### Background

In welding metals it has become somewhat common practice to use inert gas welding techniques. Tungsten Inert Gas (TIG) or Metal Inert Gas (MIG) welding techniques are often used in automated welding machines, also known as “robotic welders” or “robotic welding machines,” because the welds are often of more uniform quality and may require less preparation and/or dean-up time than stick welding techniques.

Robotic welders may be used to automate welding process by performing the weld and handling the parts to be welded on an assembly line. However, robotic welders may have limitations in that the reach of the welding arm is limited. Efforts to create extension devices for such welders have not yielded successful results.

### SUMMARY

The present disclosure describes an extension arm and/or tube for welding apparatuses. Exemplary embodiments extend the reach of robotic welders and allow the user to customize the reach to the desired length. Exemplary embodiments are configured to allow couplers to attach to existing welders and extensions to be added to such in order to increase the length, reach, and range of the welder.

A welding extension in accordance with an aspect of the present disclosure comprises an extension bar, in which a first end of the extension bar couples to a welding tip and a second end of the extension bar couples to a welding head, such that material passes from the welding head to the welding tip through a bore in the extension bar.

Such a welding extension may further optionally comprise a guide rod coupled between the welding tip and the welding head, such that the guide rod fits within the bore of the extension bar, at least one end of the guide rod being tapered, the bore of the extension bar being nonlinear, and the guide rod comprising a flexible material.

A method for extending the range of a welding head in accordance with an aspect of the present disclosure comprises coupling a first end of an extension bar to the welding head, coupling a second end of the extension bar to a welding tip, and passing material from the welding head to the welding tip through a bore of the extension bar.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further purposes and advantages, will be better understood from the following description when considered in connection with the accompanying figures. It is to be expressly understood, however, that each of the figures is provided for the purposes of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates a stick welding apparatus in accordance with an aspect of the present disclosure;

FIG. 2 illustrates a Metal Inert Gas (MIG) apparatus in accordance with an aspect of the present disclosure;

FIG. 3 illustrates a Tungsten Inert Gas (TIG) apparatus in accordance with an aspect of the present disclosure;

FIG. 4 illustrates a welding extension in accordance with an aspect of the present disclosure;

FIG. 5 illustrates a welding extension in accordance with an aspect of the present disclosure; and

FIG. 6 illustrates a process flow in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

### Overview

The use of welding to attach various forms of metal together has been used in many applications. Some applications for welding are well-known; automobile parts, furniture, etc. Further, some welding techniques are done in open air factories by robots, while others may be performed in high-pressure (hyperbaric) conditions by robots and/or human operators. The apparatus of the present disclosure may be employed in one or more of these applications as needed in accordance with various aspects of the present disclosure.

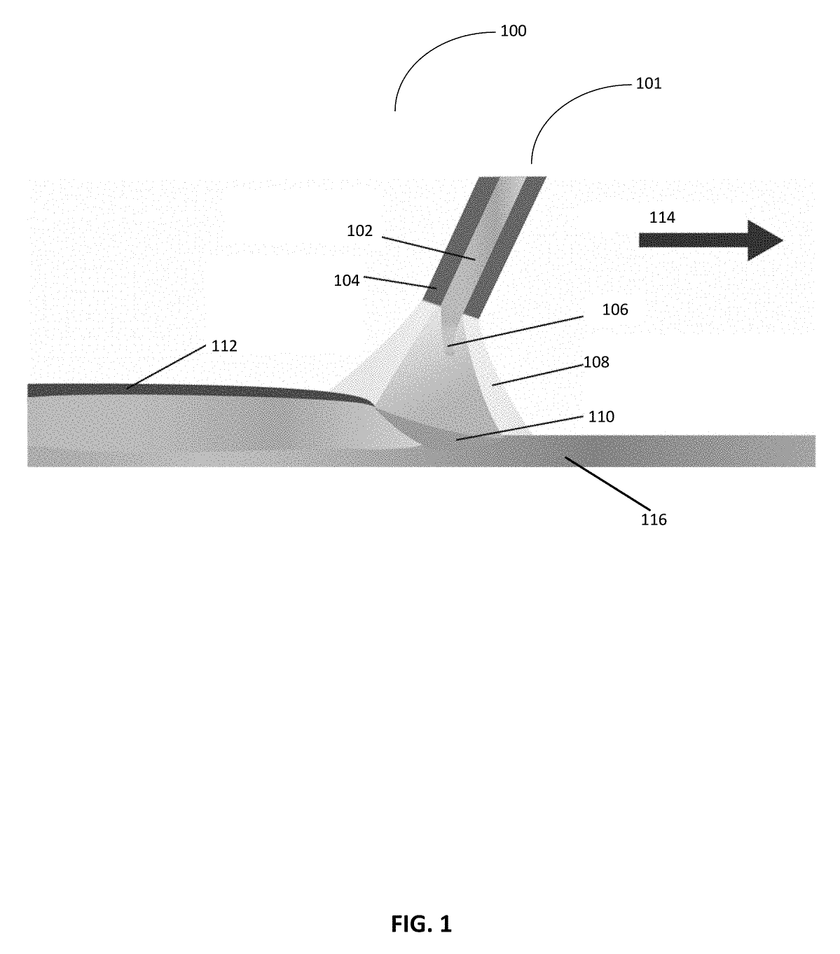

FIG. 1 illustrates a stick welding apparatus in accordance with an aspect of the present disclosure.

Stick welding, also known as shielded metal arc welding, is a cost efficient welding process. Weld 100 shows an electrode 102, a flux coating 104, an arc 106, a gas shield 108, a weld pool 110, and slag 112.

In shielded metal arc welding, a rod 101, which comprises electrode 102 and flux coating 104, is used to make the weld 100. To create the weld 100, the electrode 102 is energized with electricity and moved in direction 114, and the metal workpiece 116 and electrode 102/flux coating 104 all melt, forming weld pool 110. The electrode 102 becomes arc 106 as it melts, and the flux coating 104 emits vapors that become gas shield 108, which protects the molten electrode 102 (as arc 106) from oxidizing, other atmospheric contamination, and/or other deleterious interactions. The weld pool 110 then cools to form slag 112, which is the weld joint.

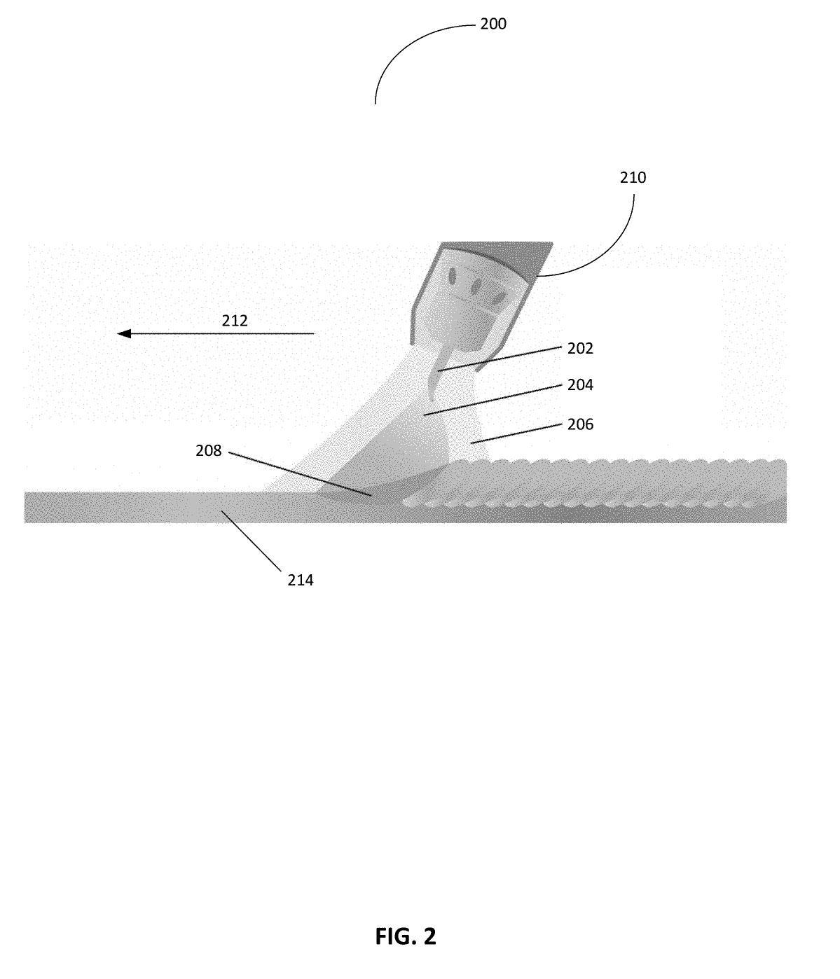

FIG. 2 illustrates a Metal Inert Gas (MIG) apparatus in accordance with an aspect of the present disclosure.

MIG welding uses a shielding gas, along with a variable speed feeding of a wire electrode, to create the weld. Weld 200 comprises wire electrode 202, arc 204, shielding gas 206, and weld pool 208. When welding gun 210 is moved in direction 212 proximate material 214, wire electrode 202 is heated and/or electrified such that wire electrode is melted into arc 204, and material 214 is melted with arc 204 in weld pool 208. Shielding gas 206 protects the arc 204/weld pool 208 from atmospheric gases such as nitrogen and oxygen, which can cause problems if such atmospheric gases contact the wire electrode 202, the arc 204, or the weld pool 208.

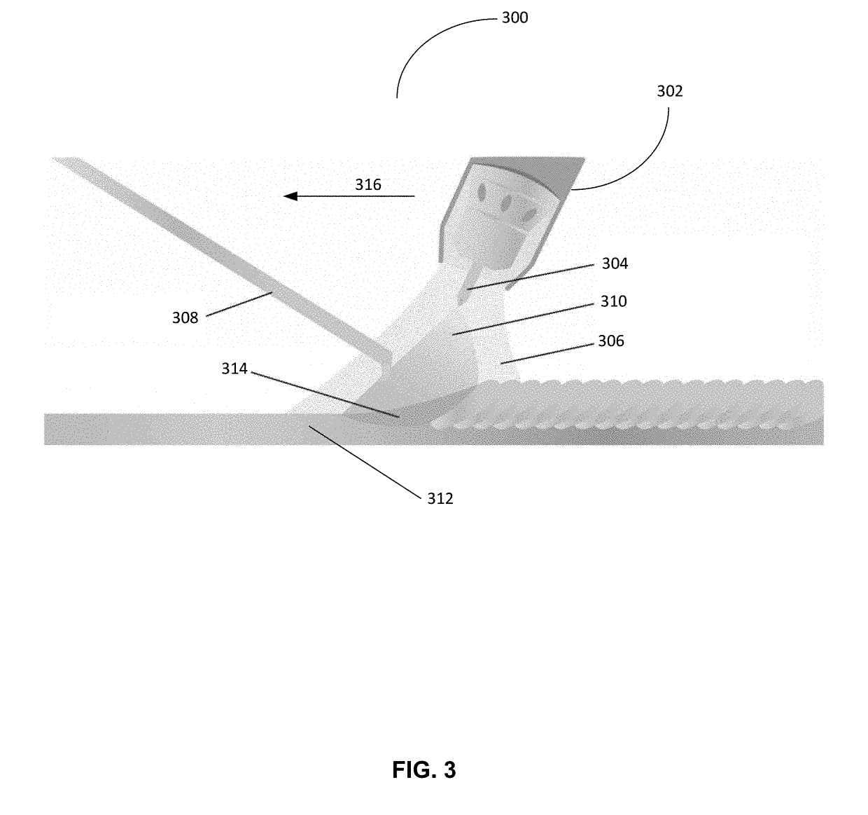

FIG. 3 illustrates a Tungsten Inert Gas (TIG) apparatus in accordance with an aspect of the present disclosure.

Similar to a combination of stick welding shown in FIG. 1 and MIG welding shown in FIG. 2, TIG weld 300 is made with a welding gun 302 comprising a tungsten electrode 304 and emitting a shielding gas 306. Instead of the tungsten electrode 304 being consumed by the TIG weld 300 process, a filler rod 308 is heated by arc 310, such that filler rod 308 and material 312 melt together in weld pool 314 as welding gun 302 and filler rod 308 are moved in direction 316.

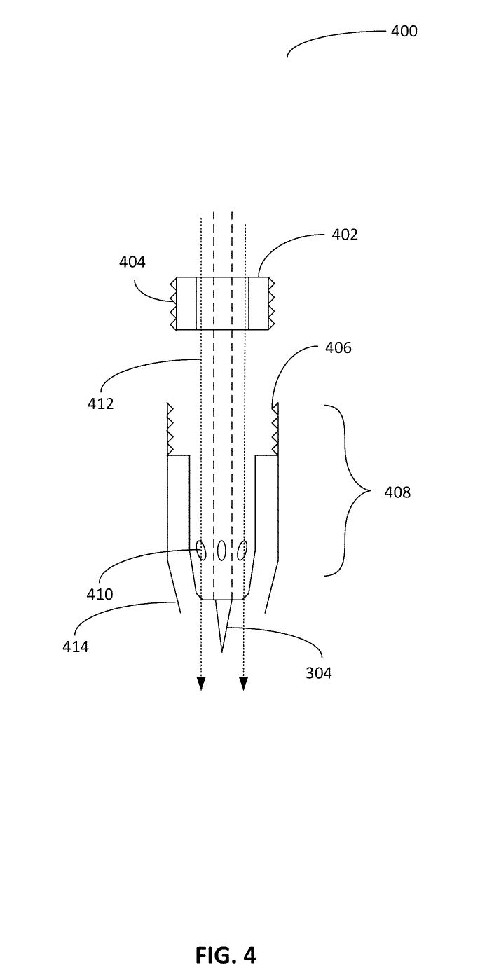

FIG. 4 illustrates a welding nozzle connection in accordance with an aspect of the present disclosure.

As shown in FIGS. 1-3, the welding rod 101, and welding guns (or tips) 210 and 302, are proximate the area of the weld being created. For some welds, a short-tipped welding apparatus cannot reach the desired location of the weld. In an aspect of the present disclosure, systems, devices, and methods for extending the reach of a welder apparatus are disclosed herein.

A welder extension in accordance with an aspect of the present disclosure comprises a coupler, an extension tube, and a guide rod. The coupler attaches to a head of a welding apparatus. The extension tube attaches to the coupler. The guide rod is placed into the extension tube. The welding tip (also referred to as a welding nozzle herein) is coupled to the extension tube.

As shown in FIG. 4, assembly 400 illustrates head 402 of a welding apparatus. Head 402 may have threads 404, which allow for coupling threads 406 of welding tip 408 to threads 404 of head 400. Electrode 304 (and/or rod 101, and/or electrode 202, depending on the type of welding apparatus is being used) extends from head 402 through welding tip 408. Further, any inert gas 206 and/or 306 flows through head 402 and out of ports 410 as shown by path 412. Nozzle shield 414 concentrates the inert gas 206 and/or 306 flowing from ports 410 around electrode 202 and/or 304 to avoid contamination of any weld created with welding tip 408.

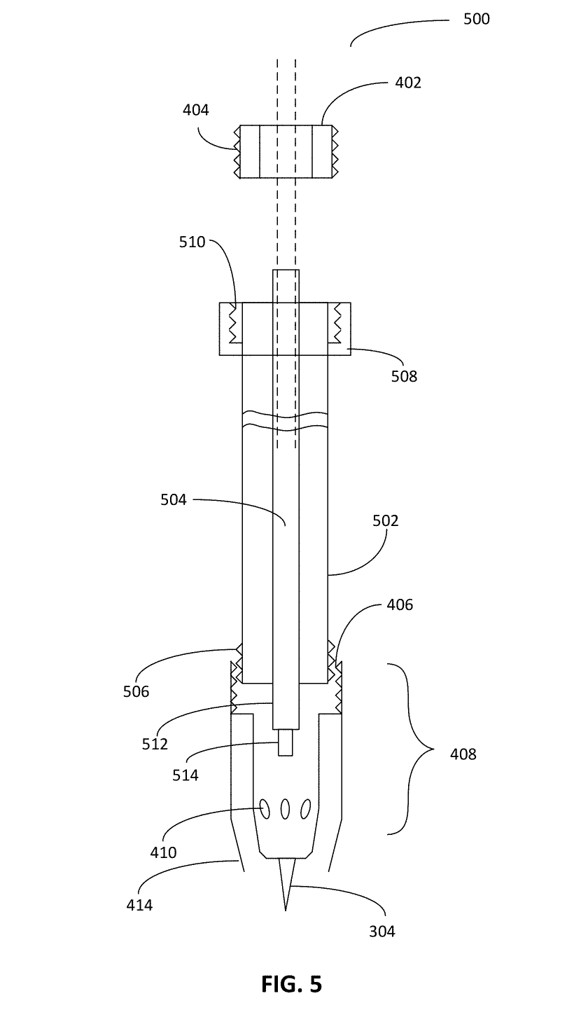

FIG. 5 illustrates a welding extension in accordance with an aspect of the present disclosure.

Welder 500 comprises extension 502. In an aspect of the present disclosure, extension 502 may be created from a solid bar of metal or other suitable material. The bar can then be drilled to create bore 504, and threaded with threads 506 which mate with threads 406 of welding tip 408. The other end 508 of extension 502 may also be threaded with threads 510 to mate with threads 404 of head 402. Threads 404, 406, 506, and 510 may allow for any type of connection, e.g., bayonet, quick-connect, pipe thread, etc., so long as the function of welder 500 is not significantly degraded. Extension 502 may have any length as desired within the scope of the present disclosure.

Material, such as shielding gas, welding wire, etc., may be passed through bore 504 of extension 502, such that welder 500 may be used with extension 502 in a similar fashion as when extension 502 is not present in welder 500. In an aspect of the present disclosure, one or more bores 504 may be created in extension 502 to allow a plurality of materials to pass between head 402 and welding tip 408 as desired.

In other aspects of the present disclosure, extension 502 may be made from a pipe or other hollow structure, such that drilling and/or boring to create 504 would not be strictly necessary. Further, extension 502 may be cast, molded, and/or otherwise created, such that extension 502 may couple to welding tip 408 and head 402 and allow for bore 504 to couple between head 402 and welding tip 408 as needed. Extension 502 may also be made of a flexible material, e.g., flexible copper pipe, flexible tubing, etc., without departing from the scope of the present disclosure. Extension 502 may also be non-linear, e.g., curved, zig-zag, etc., so long as the requisite materials can pass through bore 504 and extension 502 can be coupled to head 402 and welding tip 408.

In an aspect of the present disclosure, a guide rod 512 may be inserted into bore 504. Guide rod 512 may have a slightly longer length than extension 502, such that the ends of guide rod 512 may mate with head 402 and welding tip 408. In another aspect of the present disclosure, extension 502 may be fabricated without a guide rod 512, and the extensions of guide rod 512 may be made as part of extension 502. In aspects of the present disclosure where bore 504 is not linear, guide rod 512 may be made of a flexible material such that guide rod 512 may still traverse the length of extension 502. Further, one or more ends of the guide rod 512 may include taper 514, such that the mating of guide rod 512 and/or extension 502 to head 402 and/or welding tip 408 may be facilitated.

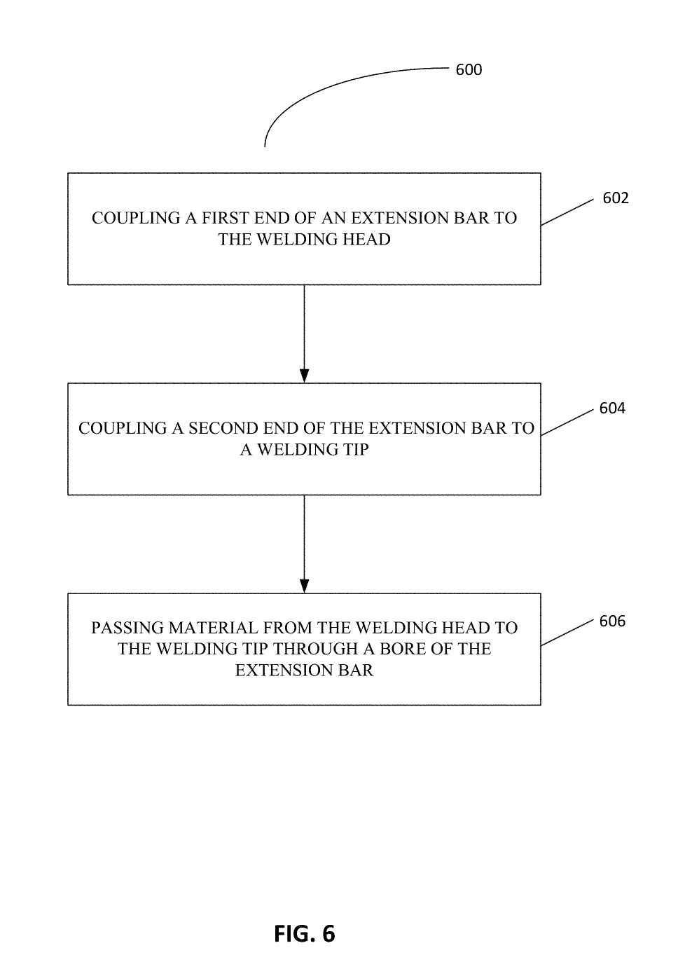

FIG. 6 illustrates a process flow in accordance with an aspect of the present disclosure.

Flow 600, which extends the range, length, or reach of a welding head, includes block 602, which illustrates coupling a first end of an extension bar to the welding head. Flow 600 also includes block 604, which illustrates coupling a second end of the extension bar to a welding tip. Flow 600 also includes block 606, which illustrates passing material from the welding head to the welding tip through a bore of the extension bar.

Although the present disclosure and its advantages have been described in detail, it should be understood that various changes, substitutions and alterations can be made herein without departing from the technology of the disclosure as defined by the appended claims. For example, relational terms, such as “above” and “below” may be used with respect to a device. Of course, if the device is inverted, above becomes below, and vice versa. Additionally, if oriented sideways, above and below may refer to sides of a device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The description of the disclosure is provided to enable any person reasonably skilled in the art to make or use the disclosure. Various modifications to the disclosure will be readily apparent to those reasonably skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

Although several embodiments have been described in detail for purposes of illustration, various modifications may be made without departing from the scope and spirit of the present disclosure. Accordingly, the disclosure is not to be limited by the examples presented herein, but is envisioned as encompassing the scope described in the appended claims and the full range of equivalents of the appended claims.

What is claimed is:

1. A welding extension, comprising;
an extension bar, in which a first end of the extension bar couples to a welding tip and a second end of the extension bar couples to a welding head, such that material passes from the welding head to the welding tip through a bore in the extension bar.

2. The welding extension of claim 1, further comprising a guide rod, coupled between the welding tip and the welding head, such that the guide rod fits within the bore of the extension bar.

3. The welding extension of claim 2, in which at least one end of the guide rod is tapered.

4. The welding extension of claim 3, in which the bore of the extension bar is nonlinear.

5. The welding extension of claim 4, in which the guide rod comprises a flexible material.

6. A method for extending the range of a welding head, comprising:
coupling a first end of an extension bar to the welding head;
coupling a second end of the extension bar to a welding tip; and
passing material from the welding head to the welding tip through a bore of the extension bar.

7. The method of claim 6, further comprising coupling a guide rod between the welding tip and the welding head, such that the guide rod fits within the bore of the extension bar.

8. The method of claim 7, in which at least one end of the guide rod is tapered.

9. The method of claim 8, in which the bore of the extension bar is nonlinear.

10. The method of claim 9, in which the guide rod comprises a flexible material.
